(19) United States
(12) Patent Application Publication
(10) Pub. No.: US 2004/0141506 A1
(43) Pub. Date: Jul. 22, 2004

(54) Switching method and apparatus

(75) Inventor: Jung-Hyun Kim, Sungnam-city (KR)

Correspondence Address: Frank Chau, F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/733,678

(22) Filed: Dec. 11, 2003

(30) Foreign Application Priority Data
Jan. 22, 2003 (KR) 2003-4189

(51) Int. Cl. H04L 12/28

(52) U.S. Cl. 370/395.31

(57) ABSTRACT

A method of switching packets includes preparing a plurality of tables wherein each table corresponds to at least one output port of a plurality of output ports, storing a plurality of input port designations in each table, wherein each input port designation corresponds to at least one input port of a plurality of input ports, storing a plurality of packet identifiers in each table, wherein each packet identifier is stored together with an input port designation of the plurality of input port designations, inputting at least one packet into an input port of the plurality of input ports, wherein the at least one packet includes a packet identifier, locating a packet identifier from the plurality of packet identifiers stored in each table that matches the packet identifier of the at least one packet, and connecting an input port corresponding to an input port designation stored with the located packet identifier, with one or more output ports of the plurality of output ports.

### TECHNICAL FIELD

The present disclosure relates to a switching method and apparatus, and more particularly to a switching method and apparatus for switching a large capacity packet or cell in a large capacity switching system, wherein the time for switching is reduced.

### BACKGROUND

A known switching apparatus of an input buffer type is shown in FIG. 1. Referring to FIG. 1, the apparatus includes a plurality of input ports 10-13, a plurality of output ports 20-23, a controller 30, a switch fabric 40 and a lookup table 50. The lookup table 50 is constructed as shown in FIG. 2. With reference to FIG. 2, reference numerals 51, 52, 53 each indicate an identifier, an output port number and another output port number, respectively. In one construction of the lookup table 50, an identifier 11 for a packet is stored at an identifier region 51a positioned in the first column, and 1, indicating an output port 1 can be stored at an output port number region 52a positioned next to the identifier region 51a. In this case, a packet having the identifier 11 is switched to an output port 1 through a switching connection provided by the switch fabric 40.

In the switching apparatus shown in FIG. 1, in order to perform a switching connection between an input port and output port, the controller 30 searches the lookup table 50 for output port destinations that correspond to identifiers of packets or cells applied to the switching apparatus through the input ports 10-13.

An increase in the size of the switch fabric 40 increases the number of the input ports and the output ports, which, in turn, greatly increases the size of the lookup table. As a result of the increased size of the lookup table, the time taken for the controller to search for a destination of the inputted packet or cell increases, thereby lengthening a switching delay. That is, an increase of the capability of the switching apparatus (i.e., more input and output options) causes an increase in the load required for making a destination decision.

Further, increasing the size of the switching apparatus makes a switching method more complicated, thus increasing the occurrence of inconsistencies or conflicts within the switch fabric, causing difficulty in completing a switching operation.

Furthermore, as shown in center and final columns of the lookup table 50 referred to in FIG. 2, the number of output ports may be more than one. The situation where there is more than one output port is called a multicast. When supporting a multicast operation, a packet may have more than one destination, causing increased switching delay and load.

The lookup table 50 referred to in FIG. 2 may be configured like a memory such as, for example, a dynamic random access memory (DRAM), and an output port number region 53a corresponding to an output port number 53 may be vacant, causing a waste of memory space.

In sum, known switching apparatuses may determine a destination of a packet or cell applied through an input port by matching the identifier of the packet or cell with an identifier in a lookup table. As a result, increasing the overall number of input and output ports of the switching apparatus causes an unwanted load increase when performing switching operations.

### SUMMARY OF THE INVENTION

According to an embodiment of the present invention, a method of switching packets includes preparing a plurality of tables, wherein each table corresponds to at least one output port of a plurality of output ports, storing a plurality of input port designations in each table, wherein each input port designation corresponds to at least one input port of a plurality of input ports, storing a plurality of packet identifiers in each table, wherein each packet identifier is stored together with an input port designation of the plurality of input port designations, inputting at least one packet into an input port of the plurality of input ports, wherein the at least one packet includes a packet identifier, locating a packet identifier from the plurality of packet identifiers stored in each table that matches the packet identifier of the at least one packet, and connecting an input port corresponding to an input port designation stored with the located packet identifier, with one or more output ports of the plurality of output ports.

At least one of the plurality of packet identifiers stored in each table may identify an input port of the plurality of input ports, and/or one output port or more than one output port of the plurality of output ports. The packet identifier of the at least one packet may identify an input port of the plurality of input ports and/or one output port or more than one output port of the plurality of output ports.

At least one packet identifier of the plurality of packet identifiers stored in each table may identify a multicast packet. The packet identifier of the at least one packet also may identify a multicast packet. Each table may be configured as a semiconductor memory. Each packet identifier may be stored together with the input port designation as one datum including a plurality of bits. The one or more output ports may be determined based on each table storing the located packet identifier.

According to an embodiment of the present invention, a method of switching cells, includes preparing a plurality of tables, wherein each table corresponds to at least one output port of a plurality of output ports, storing a plurality of input port designations in each table, wherein each input port designation corresponds to at least one input port of a plurality of input ports, storing a plurality of cell identifiers in each table, wherein each cell identifier is stored together with an input port designation of the plurality of input port designations, inputting at least one cell into an input port of the plurality of input ports, wherein the at least one cell includes a cell identifier, locating a cell identifier from the plurality of cell identifiers stored in each table that matches the cell identifier of the at least one cell, and connecting an input port corresponding to an input port designation stored with the located cell identifier, with one or more output ports of the plurality of output ports.

At least one of the plurality of cell identifiers stored in each table may identify an input port of the plurality of input ports and/or one output port or more than one output port of the plurality of output ports. The cell identifier of the at least one cell may identify an input port of the plurality of input ports and/or one output port or more than one output port of the plurality of output ports.

At least one cell identifier of the plurality of cell identifiers stored in each table may identify a multicast cell. The cell identifier of the at least one cell also may identify a multicast cell. Each table may be configured as a dynamic random access memory. Each cell identifier may be stored together with the input port designation as one datum including a plurality of bits. The one or more output ports may be determined based on each table storing the located cell identifier.

According to an embodiment of the present invention, a switching apparatus includes a plurality of input ports, wherein each of the plurality of input ports is capable of receiving at least one packet including a packet identifier, a plurality of output ports, a plurality of tables for storing a plurality of packet identifiers and a plurality of input port designations corresponding to the plurality of input ports, wherein each table corresponds to at least one output port of the plurality of output ports and stores each packet identifier together with an input port designation of the plurality of input port designations, a switching control unit for outputting a signal for connecting an input port corresponding to an input port designation stored with the packet identifier of the at least one packet, with at least one output port of the plurality of output ports.

The switching unit may connect the input port corresponding to the input port designation stored with the packet identifier of the at least one packet with the at least one output port.

According to an embodiment of the present invention, a method of switching packets, includes storing a plurality of input port designations in at least one table, wherein each input port designation corresponds to at least one input port of a plurality of input ports, storing a plurality of packet identifiers in the at least one table, wherein each packet identifier is stored together with an input port designation of the plurality of input port designations, inputting at least one packet into an input port of the plurality of input ports, wherein the at least one packet includes a packet identifier, locating a packet identifier from the plurality of packet identifiers stored in the at least one table that matches the packet identifier of the at least one packet, and connecting an input port corresponding to an input port designation stored with the located packet identifier, with at least one output port of the plurality of output ports.

According to an embodiment of the present invention, a program storage device readable by a machine, tangibly embodying a program of instructions executable by the machine to perform method steps for switching a packet, the method steps including storing a plurality of input port designations in at least one table, wherein each input port designation corresponds to at least one input port of a plurality of input ports, storing a plurality of packet identifiers in the at least one table, wherein each packet identifier is stored together with an input port designation of the plurality of input port designations, inputting at least one packet into an input port of the plurality of input ports, wherein the at least one packet includes a packet identifier, locating a packet identifier from the plurality of packet identifiers stored in the at least one table that matches the packet identifier of the at least one packet, and connecting an input port corresponding to an input port designation stored with the located packet identifier, with at least one output port of the plurality of output ports.

### BRIEF DESCRIPTION OF THE DRAWINGS

Preferred embodiments of the invention can be understood in more detail from the following descriptions in conjunction with the accompanying drawings, in which:

FIG. 1 is a block diagram of a conventional switching apparatus;

FIG. 2 is a format diagram of a lookup table shown in FIG. 1;

FIG. 3 is a block diagram of a switching apparatus according to an embodiment of the present invention;

FIG. 4 is a diagram of a switch fabric shown in FIG. 3, according to an embodiment of the present invention;

FIG. 5 is a diagram of lookup tables shown in FIG. 3, according to an embodiment of the present invention; and

FIG. 6 is a block diagram of the switching apparatus shown in FIG. 3, according to an embodiment of the present invention.

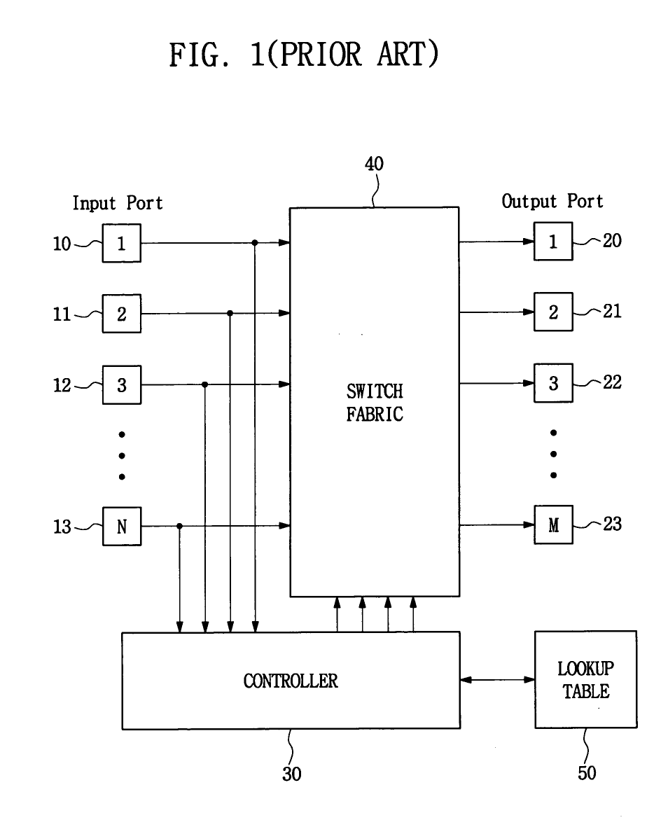

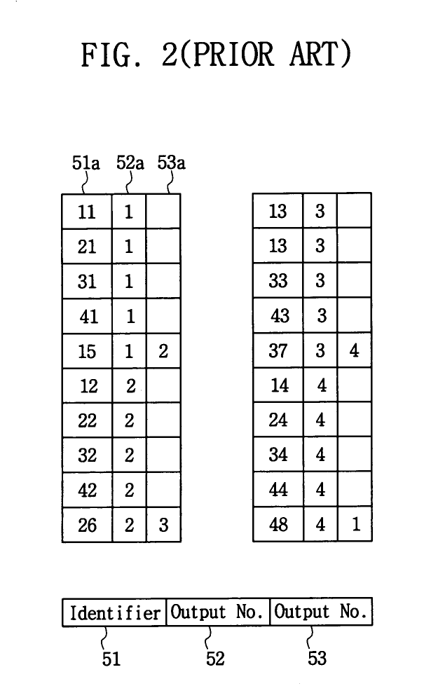

### DETAILED DESCRIPTION OF THE PREFERRED EMBODIMENTS

Preferred embodiments of the present invention will now be described more fully hereinafter below in more detail with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

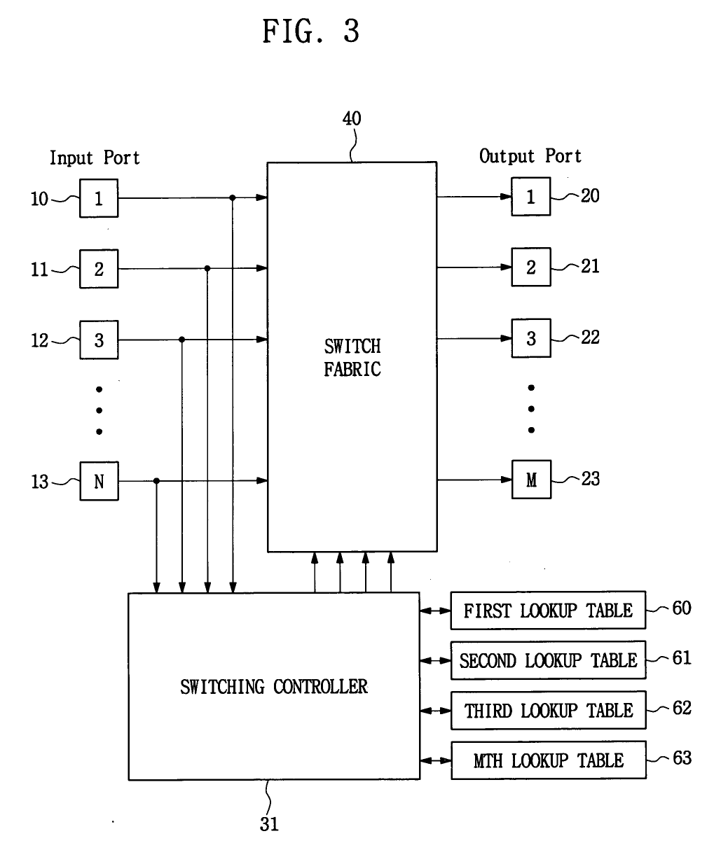

FIG. 3 is a block diagram of a switching apparatus according to an embodiment of the present invention. Referring to FIG. 3, the switching apparatus includes a plurality of input ports 10-13, a plurality of output ports 20-23, a switching controller 31, a switch fabric 40, and a plurality of lookup tables 60-63. Each of the lookup tables 60-63 corresponds to each of the output ports 20-23 and is constructed as shown in FIG. 5. The lookup tables 60-63 may be in the form of a semiconductor memory such as, for example, a dynamic random access memory (DRAM).

Referring to FIG. 5, the lookup tables 60-63 each have storage regions, for example, 60a-60f and 63a-63f. Each individual storage region stores both an identifier and an input port number. The identifier and the input port number may be stored as one datum including a plurality of bits. For example, the numbers 11 and 1 in storage region 60a indicate an identifier, and an input port number, respectively. Further, the two numerals making up the identifier can respectively designate the input port and output port(s). For example, if there are four input ports and four output ports, identifiers, 11, 12, 13, and 14 indicate packets or cells directed from a first input port to respective first, second, third and fourth output ports, and identifier 15 designates a multicast packet or cell directed from a first input port to first and second output ports. Similarly, identifiers 21-24, 31-34 and 41-44 indicate packets or cells directed from respective second, third and fourth input ports to first through fourth output ports. Identifiers 25, 35 and 45 indicate multicast packets or cells directed from respective second, third and fourth input ports to second and third, third and fourth, and fourth and first output ports, respectively.

In addition, each respective lookup table 60-63 stores only information for identifiers directed to a specific output port. For example, lookup table 60 stores information for identifiers directed to a first output port and lookup table 63 stores information for identifiers directed to a fourth output port. Therefore, an identifier applied to the switching apparatus through an input port can be searched for in lookup tables of all output ports simultaneously, so that the time taken to search for a destination is substantially reduced. Use of such lookup tables reduces a load for a destination decision, allowing use of a lower speed memory when compared with conventional switching apparatuses.

Further, in a multicast case, one input port can be simultaneously connected with multiple output ports based on the multicast identifier. The multicast identifier appears in the lookup tables corresponding to those output ports to which the identifier is directed. For example, the identifier 15 appears in lookup tables 60 and 61 corresponding to first and second output ports. Accordingly, multiple output ports are easily connected to one input port, thereby facilitating a switching operation for multicast packets or cells.

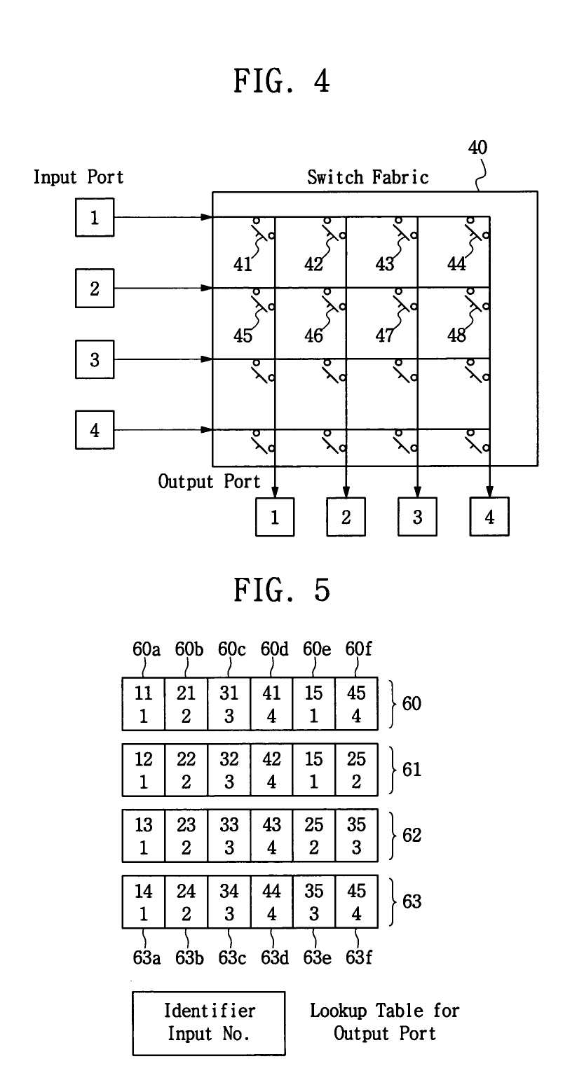

FIG. 4 shows the switch fabric 40 of FIG. 3, according to an embodiment of the present invention. Referring to FIG. 4 illustrating a cross-bar switch, for example, if a switch 41 among a plurality of switches is turned on in response to a control signal from the switching controller 31, a packet or cell applied through a first input port is transmitted to a first output port.

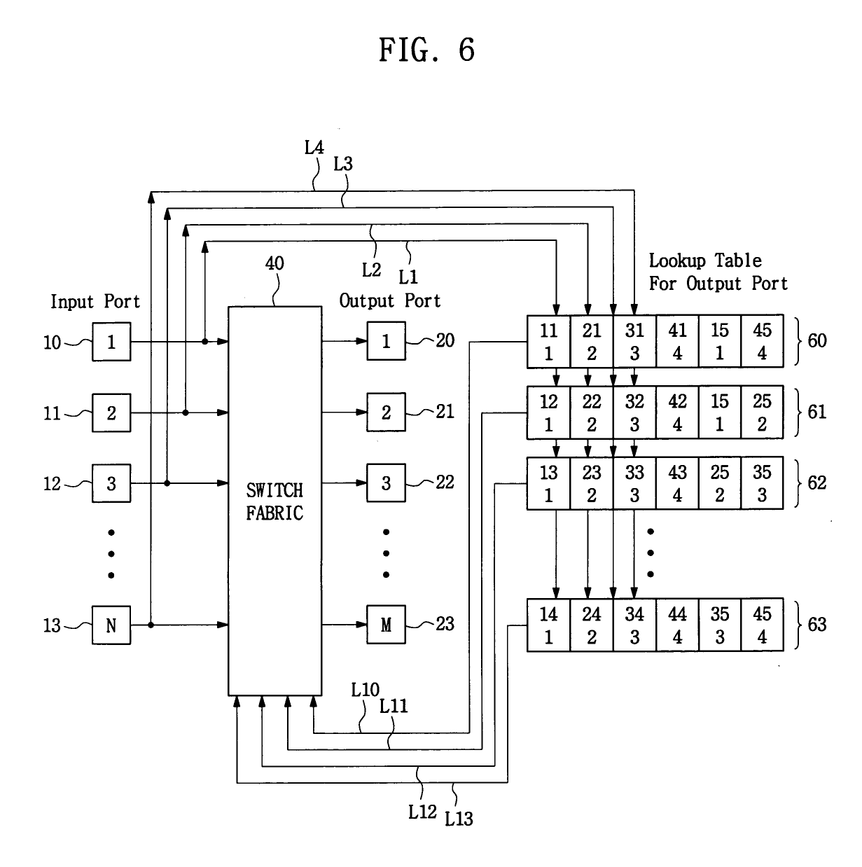

FIG. 6 illustrates a switching operation with four input ports and four output ports. Although the switching operation is performed using the switching controller 31 shown in FIG. 3, a block of the switching controller 31 is omitted from FIG. 6 and the description for brevity.

With reference to FIG. 6, a packet or cell applied through any one of input ports 10-13 can be directed to each output port 20-23 via lines L1-L4 and L10-L13. A packet or cell applied through an input port includes an identifier directed one or more specific output ports. For example, as stated above, a front number can indicate an input port, and a back number can represent an output port. Therefore, an identifier directed from a first input port to a first output port is 11, an identifier directed to a second output port is 12, an identifier directed to a third output port is 13, and an identifier directed to a fourth output port is 14. The second, third and fourth input ports each have similar identifiers, for example front numbers 2, 3 and 4 representing second, third and fourth input ports, respectively. Also, an identifier 15 may indicate a multicast packet or cell that is directed from the first input port to the first and second output ports. Likewise, identifiers 25, 35, 45 each indicate a multicast packet or cell directed to second and third output ports, third and four output ports, and four and first output ports, respectively.

As described above, a lookup table for each output port is constructed with storage regions including an identifier and an input port number of a packet or cell as shown in FIG. 5. For instance, a packet or cell inputted with an identifier 25 appears in lookup tables 61 and 62 and is therefore registered in all the second and third output ports. As a result, the switch fabric 40 is constructed so that the second and third output ports receive the packet or cell inputted with the identifier 25 from the second input port. Therefore, the size of the lookup table and a delay from the input port to the output port is substantially reduced, and an operation including a multicast packet or cell can be easily supported.

Consequently, in an embodiment of the present invention, identifiers directed to one or more output ports and an input port are stored in the lookup tables. As a result, if a packet or cell applied through an input port is matched to an identifier of the lookup table, the input port can be immediately connected to the output port. A load for the destination decision can be substantially reduced and conflicts within the switch fabric do not occur. In addition, a memory region necessary for configuring the lookup table is reduced, resulting in more efficient use of the memory to easily support a multicast.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method of switching packets, comprising:
preparing a plurality of tables, wherein each table corresponds to at least one output port of a plurality of output ports;
storing a plurality of input port designations in each table, wherein each input port designation corresponds to at least one input port of a plurality of input ports;
storing a plurality of packet identifiers in each table, wherein each packet identifier is stored together with an input port designation of the plurality of input port designations;
inputting at least one packet into an input port of the plurality of input ports, wherein the at least one packet includes a packet identifier;
locating a packet identifier from the plurality of packet identifiers stored in each table that matches the packet identifier of the at least one packet; and
connecting an input port corresponding to an input port designation stored with the located packet identifier, with one or more output ports of the plurality of output ports.

2. The method as recited in claim 1, wherein at least one of the plurality of packet identifiers stored in each table identifies an input port of the plurality of input ports.

3. The method as recited in claim 1, wherein at least one of the plurality of packet identifiers stored in each table identifies one output port or more than one output port of the plurality of output ports.

4. The method as recited in claim 1, wherein the packet identifier of the at least one packet identifies an input port of the plurality of input ports.

5. The method as recited in claim 1, wherein the packet identifier of the at least one packet identifies one output port or more than one output port of the plurality of output ports.

6. The method as recited in claim 1, wherein at least one packet identifier of the plurality of packet identifiers stored in each table identifies a multicast packet.

7. The method as recited in claim 1, wherein the packet identifier of the at least one packet identifies a multicast packet.

8. The method as recited in claim 1, wherein each table is configured as a semiconductor memory.

9. The method as recited in claim 1, wherein each packet identifier is stored together with the input port designation as one datum including a plurality of bits.

10. The method as recited in claim 1, wherein the one or more output ports are determined based on each table storing the located packet identifier.

11. A method of switching cells, comprising:
preparing a plurality of tables, wherein each table corresponds to at least one output port of a plurality of output ports;
storing a plurality of input port designations in each table, wherein each input port designation corresponds to at least one input port of a plurality of input ports;
storing a plurality of cell identifiers in each table, wherein each cell identifier is stored together with an input port designation of the plurality of input port designations;
inputting at least one cell into an input port of the plurality of input ports, wherein the at least one cell includes a cell identifier;
locating a cell identifier from the plurality of cell identifiers stored in each table that matches the cell identifier of the at least one cell; and
connecting an input port corresponding to an input port designation stored with the located cell identifier, with one or more output ports of the plurality of output ports.

12. The method as recited in claim 11, wherein at least one of the plurality of cell identifiers stored in each table identifies an input port of the plurality of input ports.

13. The method as recited in claim 11, wherein at least one of the plurality of cell identifiers stored in each table identifies one output port or more than one output port of the plurality of output ports.

14. The method as recited in claim 11, wherein the cell identifier of the at least one cell identifies an input port of the plurality of input ports.

15. The method as recited in claim 11, wherein the cell identifier of the at least one cell identifies one output port or more than one output port of the plurality of output ports.

16. The method as recited in claim 11, wherein at least one cell identifier of the plurality of cell identifiers stored in each table identifies a multicast cell.

17. The method as recited in claim 11, wherein the cell identifier of the at least one cell identifies a multicast cell.

18. The method as recited in claim 11, wherein each table is configured as a dynamic random access memory.

19. The method as recited in claim 11, wherein each cell identifier is stored together with the input port designation as one datum including a plurality of bits.

20. The method as recited in claim 11, wherein the one or more output ports are determined based on each table storing the located cell identifier.

21. A switching apparatus comprising:
a plurality of input ports, wherein each of the plurality of input ports is capable of receiving at least one packet including a packet identifier;
a plurality of output ports;
a plurality of tables for storing a plurality of packet identifiers and a plurality of input port designations corresponding to the plurality of input ports, wherein each table corresponds to at least one output port of the plurality of output ports and stores each packet identifier together with an input port designation of the plurality of input port designations;
a switching control unit for outputting a signal for connecting an input port corresponding to an input port designation stored with the packet identifier of the at least one packet, with at least one output port of the plurality of output ports.

22. The switching apparatus as recited in claim 21, wherein the switching unit connects the input port corresponding to the input port designation stored with the packet identifier of the at least one packet with the at least one output port.

23. A method of switching packets, comprising:
storing a plurality of input port designations in at least one table, wherein each input port designation corresponds to at least one input port of a plurality of input ports;
storing a plurality of packet identifiers in the at least one table, wherein each packet identifier is stored together with an input port designation of the plurality of input port designations;
inputting at least one packet into an input port of the plurality of input ports, wherein the at least one packet includes a packet identifier;
locating a packet identifier from the plurality of packet identifiers stored in the at least one table that matches the packet identifier of the at least one packet; and
connecting an input port corresponding to an input port designation stored with the located packet identifier, with at least one output port of the plurality of output ports.

24. A program storage device readable by a machine, tangibly embodying a program of instructions executable by the machine to perform method steps for switching a packet, the method steps comprising:
storing a plurality of input port designations in at least one table, wherein each input port designation corresponds to at least one input port of a plurality of input ports;
storing a plurality of packet identifiers in the at least one table, wherein each packet identifier is stored together with an input port designation of the plurality of input port designations;
inputting at least one packet into an input port of the plurality of input ports, wherein the at least one packet includes a packet identifier;
locating a packet identifier from the plurality of packet identifiers stored in the at least one table that matches the packet identifier of the at least one packet; and
connecting an input port corresponding to an input port designation stored with the located packet identifier, with at least one output port of the plurality of output ports.
